(19) United States
(12) Patent Application Publication
(10) Pub. No.: US 2009/0107840 A1
(43) Pub. Date: Apr. 30, 2009

(54) METHODS, SYSTEMS AND APPARATUS FOR DETERMINING COMPOSITION OF FEED MATERIAL OF METAL ELECTROLYSIS CELLS

(75) Inventors: Jayson Tessier, Quebec (CA); Carl Duchesne, Boischatel (CA); Claude Gauthier, Quebec (CA); Gilles Dufour, Quebec (CA)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignees: Alcoa Inc., Pittsburgh, PA (US); Universite Laval, Quebec (CA)

(21) Appl. No.: 12/257,683

(22) Filed: Oct. 24, 2008

Related U.S. Application Data
(60) Provisional application No. 60/982,644, filed on Oct. 25, 2007.

(51) Int. Cl. G01N 27/26

(52) U.S. Cl. 204/407

(57) ABSTRACT

Systems and methods for determining compositions of cover materials for electrolysis cells are provided. In one embodiment a system includes an aluminum electrolysis cell adapted to contain an electrolytic bath, a hopper configured to provide a cover material to the aluminum electrolysis cell, where the cover material includes alumina and electrolytic bath particulate, an imaging device configured to capture images of the cover material, an image processor configured to analyze the images and output imaging data relating to the cover material, and a data analyzer configured to analyze the imaging data and output a determined cover material composition in the form of cover material information. The cover material information may be used to manage operation of the aluminum electrolysis cell, such as via adjusting the composition or feed rate of the cover material.

### CROSS-REFERENCE TO RELATED APPLICATION

This application claims priority to U.S. Provisional Patent Application No. 60/982,644, filed Oct. 25, 2007, entitled “METHODS AND SYSTEMS FOR DETERMINING COMPOSITION OF FEED MATERIAL OF METAL ELECTROLYSIS CELLS”, which is incorporated herein by reference.

### BACKGROUND

Primary aluminum metal is generally produced via the Hall process, which generally entails passing current through an electrolytic bath comprising alumina and cryolite to reduce the alumina to aluminum metal. An electrolysis cell generally holds the electrolytic bath and includes a cathode that passes current through the bath to a plurality of anodes. Each electrolysis cell generally includes a refractory sidewall material that surrounds the electrolytic bath and, in conjunction with the cathode, defines a container that contains the electrolytic bath. During metal production, a crust generally develops over the electrolytic bath. Crust that develops on the sidewall is generally called a ledge. The ledge generally prevents the electrolytic bath from leaking out of the cell via cracks between sidewall materials.

Anodes of electrolysis cells are consumed during the electrolytic process and must be regularly replaced. An aluminum smelting facility generally includes at least one line of electrolysis cells, or pots, connected in series. This series of electrolysis cells is referred to as a potline, and the facility containing the potline is generally called a potroom.

To facilitate maintenance of the crust, a feed material, often called a cover material, may be periodically added to each electrolysis cell to cover newly set anodes and/or to fill crust holes. This cover material generally comprises alumina and electrolytic bath particulate. Under the effect of heat escaping from the electrolytic bath, the cover material is converted into crust. Crust integrity is generally a function of at least crust thickness and alumina content. Therefore, maintaining a consistent cover material composition may assist in achieving stable operation, high productivity and good environmental performance for the electrolysis cells.

Conventionally, cover material is produced by mixing secondary alumina and electrolytic bath, and this mixture is delivered to pot-tending-machines (PTM) or hoppers. Uneven mixing and/or segregation are frequently encountered within PTMs, resulting in deviations from target cover material compositions. To ascertain the scope of these variations, a few samples of the cover material may be manually extracted and analyzed via laboratory analysis. Thus, it is not regularly known whether the cover material comprises a composition suited for use in the electrolysis cells.

### SUMMARY OF THE DISCLOSURE

Broadly, the instant disclosure relates to systems, methods and apparatus for determining a quality of a material to be supplied to an electrolysis cell.

In one approach, a method includes operating an aluminum electrolysis cell to produce aluminum metal, supplying a first material to the aluminum electrolysis cell, where the first material comprises a first constituent and a second constituent, obtaining, concomitant to the supplying step, images of the first material, and producing constituent information based on the images. In one embodiment, a method includes managing the operating an aluminum electrolysis cell step based on the producing constituent information step.

In one embodiment, the constituent information comprises information relating to a quality of at least one of the first constituent and the second constituent of the first material. In one embodiment, the constituent information comprises information relating to a concentration of at least one of the first constituent and the second constituent of the first material. In one embodiment, the constituent information comprises information relating to a physical attribute of at least one of the first constituent and the second constituent of the first material.

In one embodiment, the first material is a cover material for use in the aluminum electrolysis cell. In this regard, the first constituent may be alumina and the second constituent may be electrolytic bath particulate. Alumina is any material that predominately includes any of the various forms of aluminum oxide, including secondary alumina or enriched alumina. Electrolytic bath particulate is any particulate comprising any one of aluminum metal, alumina and cryolite (Na₃AlF₆).

In one aspect, an imaging device is used to capture one or more images of the first material. These images may be analyzed to determine a probable composition (and/or other quality) of the first material. An imaging device is any device operable to capture images utilizing electromagnetic radiation, such as a photographic device. The imaging device may operate using digital or analog technology. Digital photographic devices may obtain images in a binary data format that is readily processed by an image processor. Images are any color, black and white, or other images produced by an imaging device that depict the relative physical arrangement of objects. The images may be in digital or analog form.

In one approach, an image processor automatically completes an analysis of the images and outputs imaging data relating to the first material. An image processor is any device suited to produce imaging data based on the images. Imaging data is any data associated with one or more images of the first material. In one embodiment, the image processor is capable of completing a textural, geometrical and/or color analysis (or any other suitable analysis) of images to produce textural information, geometrical information and/or color information relating to the images. In one embodiment, the imaging data includes at least some textural information, geometric information, and/or color information. The image processor may be a separate device, or may be a part of the imaging device and/or the data analyzer. In one embodiment, the image processor includes commercially available imaging software employed with a general purpose computer.

Textural information is any information relating to a texture of an image, and may be produced by any suitable textural analysis technique, such as a statistical texture analysis technique, a structural texture analysis, a model-based textural analysis, and/or a transform-based textural analysis. A statistical texture analysis generally produces imaging data by computation of high-order moments of grayscale images, and includes analysis such as gray level co-occurrence matrix analysis. A structural texture analysis generally produces imaging data based on combinations of well-defined texture elements, such as parallel lines. The properties and placement of these texture elements define the image and may be used to produce textural information. A model-based texture analysis generally produces imaging data via empirical models of each pixel of an image based on a weighted average of surrounding pixels, and include models such as autoregressive models, Markov random field models, and fractal models. A transform-based texture analysis generally produces imaging data by converting the images in other coordinates (e.g., frequency) from which different statistical features may be determined, such as a wavelet transform analysis.

Color information is any information relating to colors of an image, and may be produced by any suitable color analysis technique, such as an RGB analysis. Geometric information is any information relating to the geometrical characteristics of an image, and may be produced via any suitable geometrical analysis technique, such as image segmentation followed by morphological and boolean operations.

In one embodiment, the image processor extracts textural information from one or more images, such as via a wavelet texture analysis (WTA) and/or a gray level co-occurrence matrix analysis (GLCM), and the imaging data includes at least some textural information. In one embodiment, the image processor extracts color information from one or more images, such as via a red-green-blue analysis (RGB), and the imaging data includes at least some color information.

A data analyzer may automatically analyze the imaging data and output the constituent information relating to the first material. A data analyzer is any device suited to produce constituent information (e.g., cover material information) based on the imaging data. In this regard, the data analyzer may employ any of various statistical analysis techniques to assist in the determination of the constituent information of the first material based on the imaging data, such as regression analysis. In one embodiment, the statistical analysis builds/employs a prediction model to output the constituent information. The model may be built via a regression analysis, which may be any of an OLS and/or PLS analysis, among others. The data analyzer may be a separate device, or may be a part of the imaging device and/or the imaging device. In one embodiment, the data analyzer includes commercially available statistical analysis software employed with a general purpose computer.

In one embodiment, a prediction model is built and/or maintained using the imaging data and/or statistical analysis. In one embodiment, imaging data is input into the prediction model, and constituent information is produced based on the prediction model. The constituent information may be utilized to manage electrolysis cell operations, such as, for example, the production of cover materials for use in electrolysis cells. In one embodiment, at least one of an ordinary least squares analysis (OLS) or partial least squares analysis (PLS) is utilized to build and/or maintain the prediction model based on the imaging data.

In one embodiment, secondary data is utilized to build and/or maintain the prediction model. In one embodiment, the secondary data relates to the characteristics of at least one constituent of the first material. In one embodiment, the secondary data relates to alumina characteristics of a cover material. In one embodiment, the secondary data includes time data, such as a time lag associated with a physical and/or chemical measurement of a constituent of the first material so as to predict the characteristics of a first material currently in use.

As noted above, the first material may be a cover material. In this regard, the constituent information may comprise cover material information. Cover material information is a quality (e.g., a concentration, a physical attribute) of a cover material based on the imaging data. In one embodiment, the cover material information includes information relating to one or both of an alumina content or electrolytic bath particulate content of the cover material.

The constituent information may include other information about the first and/or second constituents of the first material. The first material may also include more than two constituents, and in these embodiments, the constituent information may include information about the third and/or any other constituents of the first material. The methods, systems and apparatus described herein may also be utilized to determine constituent information of a second material, and separate from, or in conjunction with, the determination of the constituent information of the first material.

In a specific approach, a system includes an aluminum electrolysis cell adapted to contain an electrolytic bath, a feeder configured to provide a cover material to the aluminum electrolysis cell, wherein the cover material comprises alumina and electrolytic bath particulate, an imaging device configured to capture images of the cover material, an image processor configured to analyze the images and output imaging data relating to the cover material, and a data analyzer configured to analyze the imaging data and output cover material information. The feeder is any apparatus capable of supplying a first material to an aluminum electrolysis cell, such as a hopper, bin and the like.

In one embodiment, the data analyzer may be configured to utilize a cover material prediction model based on at least one of the cover material information and the imaging data to determine a cover material composition, wherein the cover material composition comprises composition information relating to at least one constituent (e.g., alumina) of the cover material. In one embodiment, the data analyzer may be configured to output the cover material information based on an input of imaging data into the prediction model, wherein the imaging data comprises at least one of textual information, geometrical information and color information.

In one embodiment, the system includes secondary data, wherein the secondary data includes information relating to at least of the (i) physical properties, (ii) chemical properties, and (ii) time of use data, of the cover material. In this, embodiment, the secondary data may be supplied to the data analyzer, and the data analyzer may be configured to utilize the secondary data in the output of the cover material information. In one embodiment, the secondary data includes time of use data relating to the alumina of the cover material.

In one approach, a method may comprise the steps of operating an aluminum electrolysis cell to produce aluminum metal, supplying cover material to the aluminum electrolysis cell, wherein the cover material comprises alumina and electrolytic bath particulate, obtaining, concomitant to the supplying step, images of the cover material, producing cover material information based on the images, and managing the operating an aluminum electrolysis cell step based on the producing cover material information step. In one embodiment, the managing step includes adjusting the concentration of at least one of alumina and electrolytic bath particulate in the cover material based on the cover material information.

In one embodiment, a method may include producing imaging data based on the images (e.g., after the obtaining images step), and the cover material information may be based on the imaging data. In one embodiment, this producing imaging data step may include producing at least one of textural information, geometric information and color information about the images, and the cover material information may be based on at least one of the textural information, the geometric information and the color information.

In one embodiment, the producing cover material information step may include completing a statistical analysis based on the imaging data, and outputting the cover material information in response to the statistical analysis. In one embodiment, this completing a statistical analysis step may include maintaining a cover material prediction model based on the imaging data. In one embodiment, the maintaining a cover material prediction model may include utilizing secondary data to maintain the cover material prediction model. This secondary data may relate to at least one of (i) physical properties, (ii) chemical properties, and (ii) time of use data, of the cover material.

Various ones of the novel and inventive aspects noted hereinabove may be combined to yield various systems, methods and apparatus configured to determine a quality of one or more materials that are supplied to an electrolysis cell so as to facilitate management of the operation of one or more electrolysis cells. For example, even though the description herein primarily relates to a single aluminum electrolysis cell, the teachings herein may be used to manage a plurality of aluminum electrolysis cells. Furthermore, these teachings may be utilized to manage other types of metal electrolysis cells.

These and other aspects, advantages, and novel features of the disclosure are set forth in part in the description that follows and will become apparent to those skilled in the art upon examination of the following description and figures, or may be learned by practicing the disclosure.

### BRIEF DESCRIPTION OF THE DRAWINGS

FIG. 1 is a schematic view illustrating one embodiment of an aluminum smelting facility including an imaging system for determining cover material composition.

FIG. 2 is a schematic view illustrating one embodiment of the imaging system of FIG. 1.

FIG. 3 is a schematic view illustrating four different GLCMs for an image (I) of four-gray levels.

FIG. 4 is a schematic view illustrating one embodiment of a WTA decomposition methodology.

FIG. 5 is a schematic view illustrating one embodiment of a digitized RGB image in a 3-way data array.

FIG. 6 is a schematic view illustrating one embodiment of an MPCA decomposition methodology.

FIG. 7a is a flow chart illustrating methods for determining cover material compositions and methods of managing smelting activities based thereon.

FIG. 7b is a flow chart illustrating one embodiment of a producing imaging data step.

FIG. 7c is a flow chart illustrating one embodiment of a producing cover material information step.

FIG. 8 is a graph illustrating targeted alumina content versus actual alumina content of various cover materials as measured using conventional XRF analysis.

FIG. 9 is a graph illustrating actual alumina composition (measured using XRF) and predicted alumina composition as determined using an imaging system.

FIG. 10 is a graph illustrating XRF measured cover material composition and predicted alumina composition using an imaging system.

### DETAILED DESCRIPTION

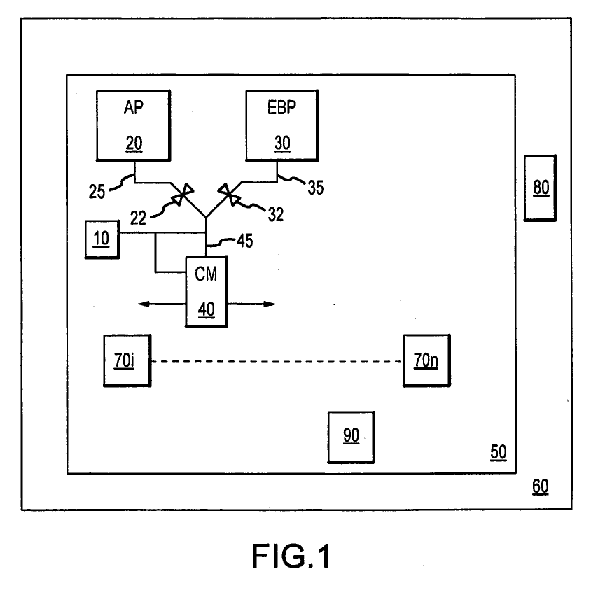

Reference is now made to the accompanying drawings, which at least assist in illustrating various pertinent features of the instant disclosure. One embodiment of an aluminum smelting facility including a cover material analysis system is illustrated in FIG. 1. In the illustrated embodiment, an alumina supply 20 comprising particulate alumina (AP) and an electrolytic bath particulate supply 30 comprising electrolytic bath particulate (EBP), are interconnected to a hopper 40 (e.g., a PTM) via supply paths 25, 35 and joining path 45. Valves 22, 32 may be included in each of supply paths 25, 35, respectively. In one embodiment, the valves 22, 32 may be individually controlled to control the amount of alumina particulate and electrolytic bath particulate supplied to the hopper 40. In one embodiment, the paths 25, 35 comprise conveyors (not illustrated), such as belt conveyors and/or screw conveyors, to name two. In one embodiment, the speed of the conveyors may be individually controlled to control the amount of alumina and electrolytic bath particulate supplied to the hopper 40. Hopper 40 may be operable to move within a potroom 50 of an aluminum smelting facility 60 to supply cover material (CM) to one or more electrolysis cells 70ᵢ-70ₙ. An imaging system 10 is utilized to obtain images of cover material CM and may be located, for example, proximal or within hopper 40 and/or joining path 45.

The imaging system 10 may obtain images, produce imaging data, and/or produce cover material information. For example, the imaging system 10 may obtain images of cover materials located within the joining path 45, within the hopper 40 and/or after the cover materials have been deposited in one or more of the electrolysis cells 70ᵢ-70ₙ.

In one approach, images of cover materials are captured concomitant to the deposit of cover material into an electrolysis cell. In this approach, the imaging system 10 may be coupled to the hopper 40 and may obtain images of cover materials upon or after they are deposited into an electrolysis cell. The hopper 40 may be interconnected to a bridge/cab adapted to move the hopper through the potroom 50, and may have the hopper 40 adjacent to/proximal to one or more potlines comprising the electrolysis cells 70ᵢ-70ₙ. In this approach, lids/hooding of the electrolysis cell may be removed to feed the cover material of the hopper 40 to the electrolysis cell. While the hooding is removed, the imaging system 10 may capture images of the deposited cover material. The hooding may then be replaced on the electrolysis cell to insulate the cell and facilitate efficient cell operation.

The images, imaging data, and/or cover material information may be communicated, for example, to a control center 80 or operating station 90, such as via wired, wireless or solid-state technology. The communicated images, data and/or information may be utilized to evaluate the cover material and determine whether such cover material is suitable for supply to one or more of the electrolysis cells 70ᵢ-70ₙ. In one approach, the feed rate of the alumina and/or electrolytic bath particulate is adjusted in response to the communication, such as via valves 22, 32 and/or via conveyor speeds, so as to adjust the composition of the cover material. Hence, management of cover material supply may be facilitated.

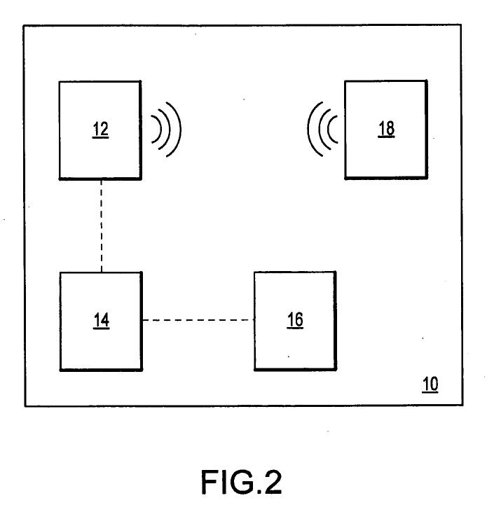

Referring now to FIG. 2, the imaging system generally includes an imaging device 12 for capturing images of cover material. The imaging system 10 may optionally include an image processor 14 and/or a data analyzer 16. Alternatively, the image processor 14 and/or data analyzer 16 may be located remote of the imaging device 12, such as at control center 80 (FIG. 1) and/or operator station 90 (FIG. 1). In one approach, the images, imaging data and/or cover material information are communicated via wired, wireless or solid state technology. In any event, imaging device 12 communicates the obtained images to the image processor, which produces imaging data based thereon. The image processor 14 may include commercially available software, such as via MATLAB (The MathWorks, Inc., 3 Apple Hill Drive, Natick, Mass.) and associated toolboxes. The image processor 14 communicates the imaging data to the data analyzer 16, which produces the cover material information based thereon. In this regard, the data analyzer may comprise commercially available statistical analysis software, such as MATLAB, and associated toolboxes.

The imaging system 10 may include other features. For example, the imaging system 10 may include a separate light source 18 to facilitate production of consistent imaging light, which may result in production of more consistent images and thus more reliable imaging data and/or cover material information. In one embodiment, the imaging system 10 is enclosed to eliminate influence of outside light. In one embodiment, one or more fluorescent light bulbs are utilized within the enclosure to produce the imaging light.

The imaging device 12 may be any suitable device adapted to produce images of cover material. In one embodiment, the imaging device 12 is an analog photographic device. In one embodiment, the imaging device 12 is a digital photographic device. In one approach, the imaging device is PANASONIC DMC-TZ1. In one approach, the imaging device is a HEWLETT-PACKARD PHOTOSMART M23 RGB, or other RGB camera with a sufficiently high resolution.

The imaging device 12 should be located proximal the cover material so as to facilitate production of images having detail sufficient to produce imaging data having sufficient differential textural, color and/or geometrical characteristics. In turn, the composition of the cover material may be determined. In one approach, a lens of the imaging device 12 is located from about 13 cm to about 15 cm away from the cover material. In this approach, the images may have a resolution of at least about 2560×1920 pixels and a cover area of at least about 175 cm². Other approaches, and thus other distances, resolutions are cover areas, are possible, and are application specific. As noted above, the images may be any of digital or analog images. The images may be color, black-and-white or other suitable images.

The imaging data may be produced via any of various image analysis techniques. In one embodiment, the imaging data includes at least some textural information. In this regard, a textural analysis may be completed to produce textural information. In one approach, a GLCM analysis is completed with respect to one or more images to produce textural information. One particular GLCM analysis technique is described below.

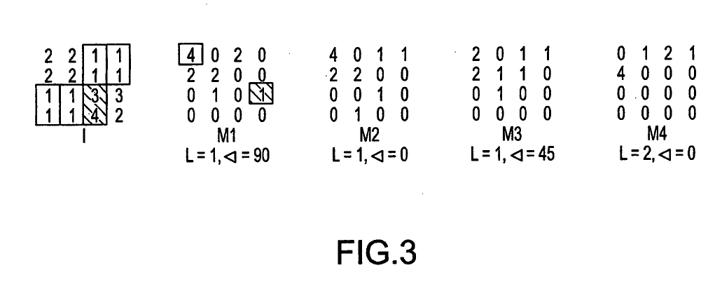

The GLCM of an image (I) is an estimate of the second order joint probability of the intensity of two pixels (i,j), located at L pixels distance and at a specified angle ( [symbol] ) from each other. This joint probability analysis leads to a square matrix whose dimensions are equal to the number of gray-levels of the image (e.g., 256 gray-level versions). However, to speed-up the analysis, GLCM may be computed on 32 gray-level versions of images, without losing too much information, consequently leading to 32×32 GLCM matrices. To illustrate the methodology, four different GLCM are presented in FIG. 3 for an image containing four gray-levels. Each GLCM has different parameters (e.g., distance, L, and angle, [symbol] ) thus capturing different textural patterns. From these GLCM matrices, it is possible to compute different statistical descriptors to quantify image textures. For example, contrast, correlation, energy and homogeneity may be computed. Contrast is a measure of the intensity contrast between a pixel and its neighbor. Correlation measures the correlation between a pixel and its neighbor. Energy is the sum of the squared elements of the GLCM. Homogeneity is related to the closeness of the elements distribution of the GLCM to the GLCM diagonal. In some applications, it may be useful to perform the analysis using different distances (L) and angles ( [symbol] ) since strongly oriented textures may manifest themselves in one of the analyzed directions (e.g., horizontal, vertical and diagonal). Moreover, fine textures will be detected with the analysis of small pixels distances compared to coarser textural patterns that will be seen with longer distances. Cover materials may not follow well-defined orientations. Thus, there may be some waves in the images, but they may not be useful to predict cover material composition. Hence, GLCM may be applied in the horizontal direction of the images ( [symbol] =0°). Distances between two pixels may be selected based on particle size. In one approach, distances of 1, 2, 5 and/or 10 pixels are selected, which may correspond to distances of 114 μm, 228 μm, 570 μm and 1140 μm, respectively, for images produced from an imaging device having an object distance of about 20 cm and a cover area of about 303 cm². GLCM may also be used in a multi-resolution analysis by combining contrast, correlation, energy and homogeneity from a plurality of pixel distances. Such a combination may produce suitable imaging data as it may account for the different textures introduced by the differences in the size distribution of alumina particulate and electrolytic bath particulate.

In another approach, a WTA is completed with respect to one or more images to produce textural information. One particular WTA technique is described below. Texture may be defined as a function of the spatial variations in pixels intensities. Since digital images may be gray-levels having a two-way discrete function (Image=f(m,n)), two-dimensional WTA may be used to decompose gray-levels into the space-frequency domain, and thus convert image information into a series of wavelet coefficients. Different textural features may be extracted from the wavelet coefficients to characterize textures contained within an image. Compared to Fourier Transforms, WTA may maintain the spatial information from the image signal, which is generally an advantage over other transform-based texture analysis method. Another advantage of WTA is that it is possible to analyze image texture at different frequencies or resolutions. This method is also known as multi-resolution since it is similar to a photographer using a zoom lens to photograph the fine details of a scene, and a standard lens to obtain a global shot of the complete scene. Hence, in terms of signal processing, WTA may analyze fine textures at high frequencies and coarser textures at lower frequencies.

To decompose a continuous signal, f(x), via WTA, the signal may be decomposed in different orthonormal bases (Ψ_{m,n}(x)) obtained through translation and dilatation of a specific mother wavelet Ψ(x), as illustrated in equation (1), below.

ψ_{m,n}(x)=2^{-m/2}ψ(2^{31 m}x−n) (1)

where m and n are the coefficients of dilatation and translation, respectively.

Similar to Fourier Transforms, different coefficients may be computed, such as via convolution of the signal with the orthonormal bases due to the orthonormal property, as illustrated in equation (2), below.

c_{m,n}=∫_{R}f(x)ψ_{m,n}(x)dx= [symbol] ψ_{m,n}, f(x) [symbol] (2)

The mother wavelet is linked to the scaling function (x) with a certain sequence of h[k], as illustrated in equations (3-5), below.

$$\begin{matrix}Ψ ( x ) = \sqrt{2} {\sum }_{k}^{ } {h}_{1} [ k ] φ ( 2 x - k ) & ( 3 ) \\ where & \\ φ ( x ) = \sqrt{2} {\sum }_{k}^{ } {h}_{0} [ k ] φ ( 2 x - k ) & ( 4 ) \\ and & \\ {h}_{1} [ k ] = {( - 1 )}^{k} {h}_{0} [ 1 - k ] & ( 5 )\end{matrix}$$

The discrete wavelet transform may be applied to a discrete signal with the use of these relations. However, the explicit forms of the scaling function and of the mother wavelet may not be required.

Hence, for the decomposition at level j,

φ_{j,1}=2^{j/2}h₀^{(j)}[k−2^{j}1] (6)

ψ_{j,1}=2^{j/2}h₁^{(j)}[k−2^{j}1] (7)

The discrete wavelet coefficients may be computed as

a₍ⱼ₎[1]= [symbol] f[k], φ_{j,1}[k] [symbol] (8)

and

d₍ⱼ₎[1]= [symbol] f[k], ψ_{j,1}[k] [symbol] (9)

Where j and l are the indices of scale and translation, respectively. The a(j)[1]'s are called the approximation coefficients and the d(j)[1]'s are the detail coefficients.

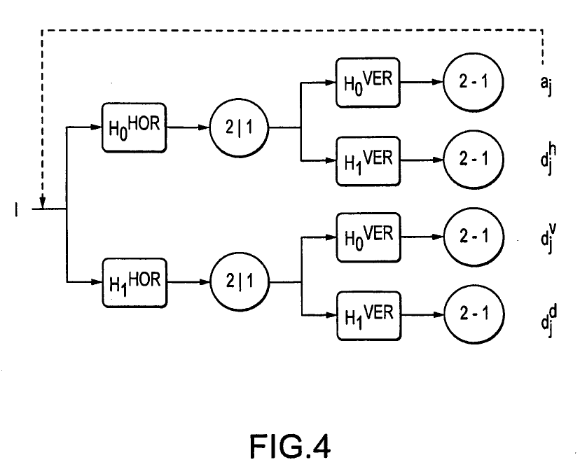

In two-dimensional discrete wavelet analysis, a discrete gray-level image may be passed through a series of low-pass and high-pass filters as illustrated in FIG. 4. The rows of pixels may first be filtered with both low-pass (H₀) and high-pass (H₁) filters, such as via equations 8, 9. A wavelet coefficient with the wavelet function may be computed for every pixel and a column-wise decimation may be performed on both filtered matrices. One out of every two columns of pixel may be kept for subsequent analysis. The column-wise decimated matrices of coefficients may again be filtered using the same two filters, but this time the filtering step is performed on the columns. This generates four matrices of coefficients, which may again be decimated. This last decimation may be performed row-wise and one out of every two rows of pixel be kept for subsequent analysis. The four resulting matrices may have half the sizes of the original image matrix. The coefficient matrix arising from the two low-pass filters may be referred to as the approximation matrix (aj). The approximation matrix may contain low frequency texture information. Based on the specific order of filtering, the three remaining decimated matrices of coefficients may be referred to as first, second and third detail matrices, since they contain high frequency textures. A first detail matrix may include horizontal textural information (dh), a second detail matrix may include vertical textural information (dv), and a third detail matrix may include diagonal textural information (dd). To extract low frequency textural information, it is possible to reintroduce the approximation matrix in the filtering loop. Thus, the first loop will provide information about high frequency textures (e.g., fine details) and the second loop of filtering may provide information about textures existing at lower frequencies (e.g., coarse details). The operations may be repeated as necessary to extract information on coarser textures. FIG. 4 illustrates a filtering process for single loop (first level) decomposition. Once an image has been filtered to the appropriate level of decomposition, statistics may be computed based on the elements of the detail matrices (dj^{h}, dj^{v}, and dj^{d}), to produce wavelet coefficients. For example, an energy coefficient may be used to summarize the textural features extracted using WTA. The textural information may include these and other coefficients.

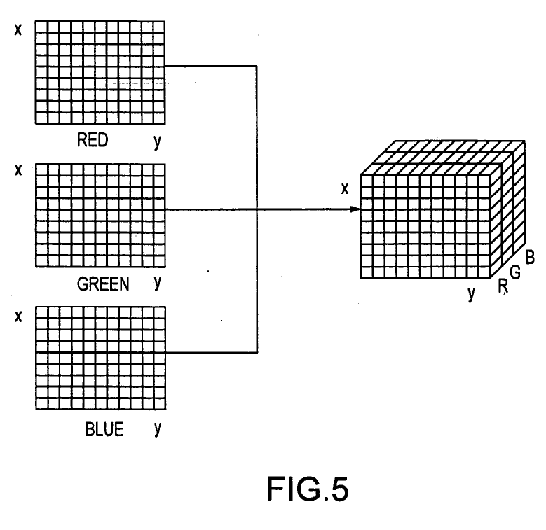

In one approach, the imaging data includes at least some color information. In this regard, a color analysis may be completed to produce color information. In one approach, a RGB analysis is completed with respect to one or more images to produce color information. Various RGB analysis are described below. Once digitized, an RGB color image generally includes of a 3-way array of data, as illustrated in FIG. 5. Each pixel is defined by two spatial coordinates (x,y) whereas the third dimension of the array corresponds to the light intensity recorded by the imaging device in the red (R), the green (G) and the blue (B) channels. For 8-bits coding cameras, the intensity values of each channel may take discrete values ranging from 0 to 255. Alternatively, the digital color image may be viewed as a stack of three different gray-level images obtained at different wavelengths of the light spectrum, that is the red, the green and the blue wavelengths (˜435, 546, and 700 nm). Color and textural features for each image may be computed from these 3-way arrays of data.

In one embodiment, full distribution of RGB color intensities is used to produce color and/or textural information. In this embodiment, the three light intensities (RGB) corresponding to each pixel are coded as discrete numbers from 0 to 255, thus leading to 256 possible light intensities values for each channel. Color features of the image are extracted using the full RGB color distributions across the image. The distribution of light intensities for each color channel (red, green and blue) may be includes in a histogram divided in 256 bins, thus leading to the extraction of 768 color features per image. These features may be stored row-wise for each image in a regressor matrix (X), which may be utilized to produce cover material information, such as via statistical analysis techniques, which are described in further detail below.

In one embodiment, mean and standard-deviation of the RGB channels are used to produce color and/or textural information. In this embodiment, only the first two moments of the full RGB color intensity distributions are utilized to produce color information. In this embodiment, the means and the standard deviations of the red, the green and the blue channels may be calculated across each image. Thus, six color features may be extracted from the images and stored row-wise in regressor matrix (X), which may be utilized to produce cover material information, such as via statistical analysis techniques.

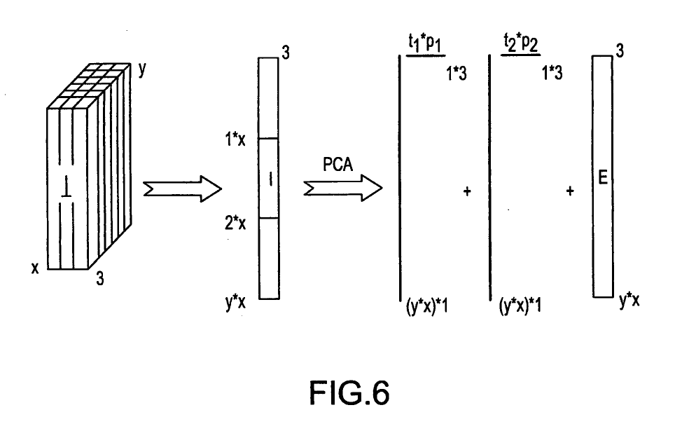

In one embodiment, a principal component analysis (PCA) of the RGB color space is completed to produce color and/or textural information. In this embodiment, a Multi-Way Principal Component Analysis (MPCA) may be performed to produce a 3-way array of data from each digitized image. One embodiment of a MPCA decomposition is illustrated in FIG. 6. In this embodiment, the digital RGB image I is first unfolded into matrix I in such a way that the columns of that matrix correspond to the red (R), green (G), and blue (B) color intensities for each pixel of the image (e.g., each row corresponds to a particular pixel of the image). PCA is then applied to matrix I, and performs an orthogonal decomposition of the covariance matrix of I into A principal components, as provided by equation (10), below

$$I = T P + E = {\sum }_{a = 1}^{A} {t}_{a} {p}_{a} + E \qquad ( 10 )$$

The decomposition of each unfolded image yields a series of A loading vectors pₐ, which corresponds to linear combinations of the RGB intensities explaining most of the variance of I, and A score vectors tₐ, resulting from the projection of each row of matrix I onto the loading vectors (tₐ=Ipₐ). Matrix E contains the residuals of this decomposition, and is zero when all principal components are used (A=3 in this case). Since the loading vectors pa (a=1,2,3) are linear combinations of the original RGB intensities of each pixel of the image that explain most of the color variations across the image, they may be viewed as representing the various color contrast of the multivariate image, and therefore may be used directly as color features. Each loading vector contains three elements or weights corresponding to the red, green, and blue colors and all three principal components are may be used to produce color information. Thus, MPCA color information may include nine features may be stored row-wise in regressor matrix (X), which may be utilized to produce cover material information, such as via statistical analysis techniques.

In one approach, the imaging data includes at least some geometrical information. In this regard, a geometrical analysis may be completed with respect to one or more images to produce geometrical information. In one approach, a segmentation algorithm, such as a Watershed-style algorithm, is utilized to produce geometrical information. Use of geometrical information is generally less preferred since it may require intensive computations. Combinations of any of the above analysis may be used to produce the imaging data.

The imaging data may be used to produce cover material information. In one approach, a statistical analysis is utilized to produce cover material information. In one embodiment, a model is utilized to produce cover material information. The model may be based on a regression analysis of historical imaging data. In this regard, any one of an ordinary least squares or partial least squares analysis may be used to build the model. Furthermore, the model may be updated based on the imaging data and/or secondary data to facilitate improved cover material composition prediction capability. One useful regression analysis and model building technique is described below.

For each obtained image, the textural, color and/or geometrical information may be stored row-wise in a regressor matrix X (k×p), where k is the total number of images in the set and p is the total number of features used in the model. To produce the model, a plurality of cover materials having known composition may be produced (e.g., a plurality of samples having an AP:EBP ratio of from about 18:82 to about 93:7), and images of each of these samples may be obtained via the imaging system 20. Baseline cover material information may be produced via conventional methodologies for each of the samples, such as via XRF analysis. The baseline cover material information may be stored in a response matrix Y (k×1). One may therefore use any appropriate regression method such as ordinary least squares (OLS) or partial least squares (PLS), to build a predictive model for cover material content.

In one approach, PLS regression is used since color and/or textural features stored in regression matrix (X) may be substantially collinear. Partial least squares regression is a latent variable (or multivariate projection) method that relates two groups of variables (e.g., X and Y) through a set of latent variables T (e.g., score vectors) as shown via equations 11-13, below:

X=TP+E (11)

Y=TQ+F (12)

T=XW (13)

where the P and Q matrices contain the loading vectors that best represent the X and Y spaces, respectively, and where W contain the loading vectors that define the relationship between the X and the Y spaces. The E and F matrices contain the residuals of each space. In PLS, the loading vectors W (linear combinations of the columns of X) may be chosen to maximize the covariance between X and Y, instead of maximizing the explained variance of each spaces separately, as is completed with a PCA (described above). The loading and score vectors of each latent dimension (or principal components) are usually calculated sequentially using a non-linear iterative partial least squares (NIPALS) algorithm. The number of components is typically determined using a cross-validation procedure that aims at selecting the model order that maximizes the predictive power of the model.

The produced cover material information may be used to predict the amount of alumina and/or electrolytic bath particulate in the cover material. The cover material information may thus be utilized to manage smelting operations, such as via adjusting a ratio of alumina to electrolytic bath particulate of the cover material, or the amount of cover material supplied to one or more electrolysis cells. Other smelting management activities may also be adjusted based on the cover material information. In turn, improved electrolytic cell performance and/or reduced emissions may be realized.

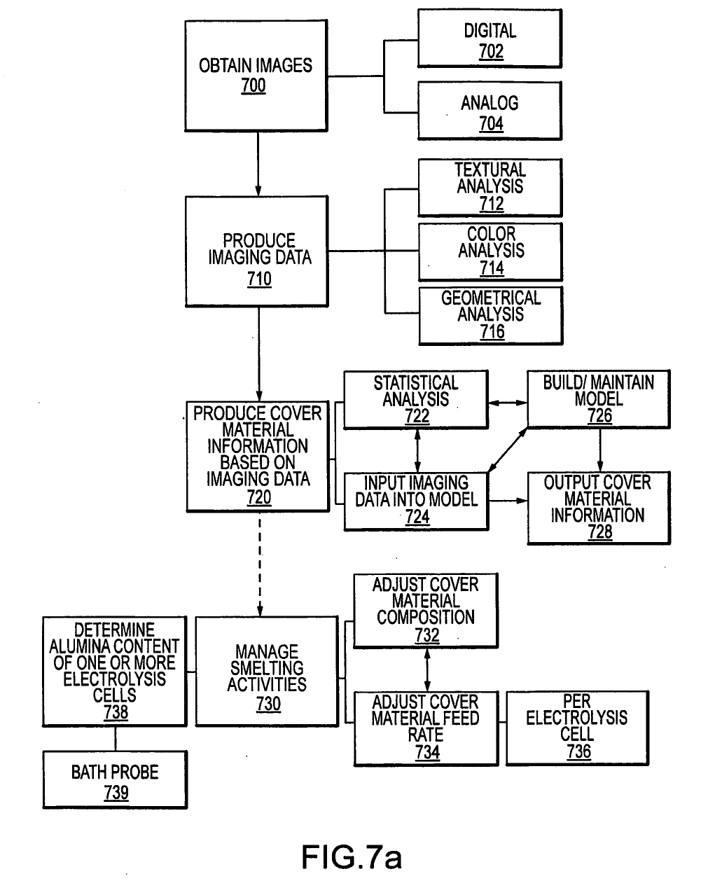

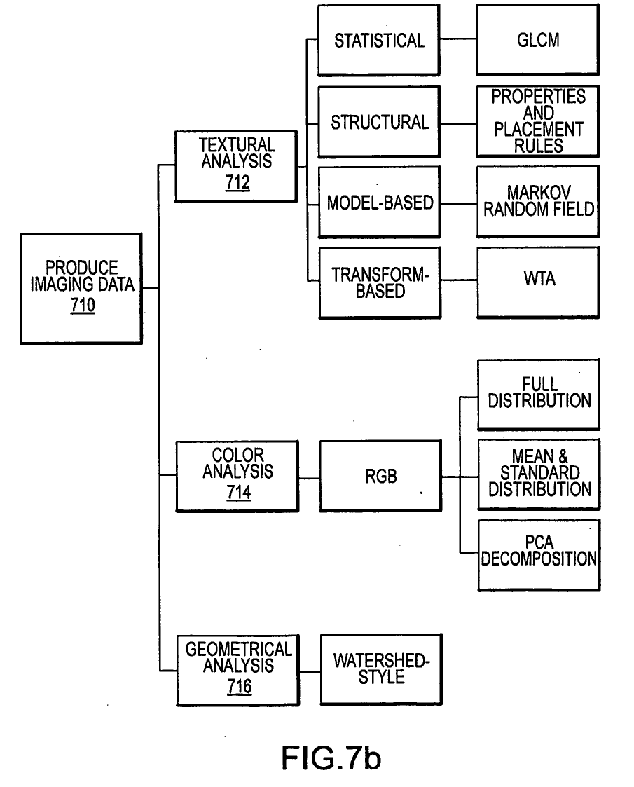

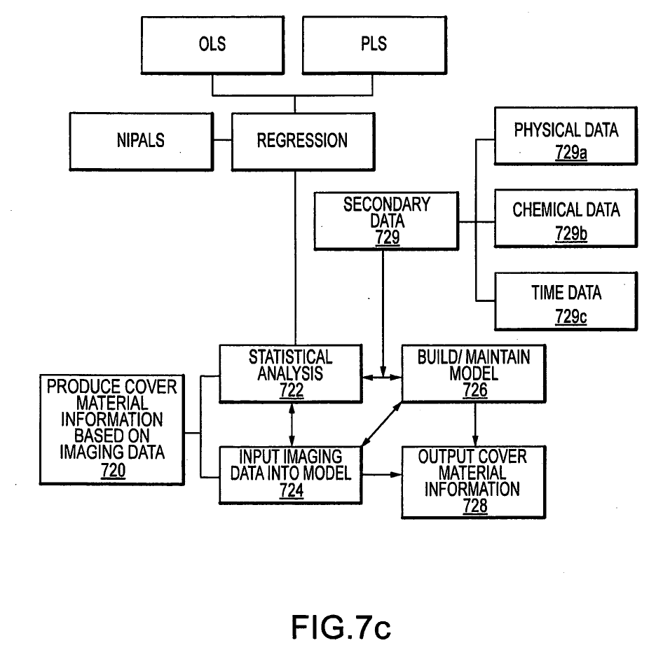

Methods relating to imaging of cover materials are also provided. In one embodiment, and with reference to FIG. 7a, a method includes the steps of obtaining images (700), producing imaging data based on the obtained images (710), and producing cover material information based on the imaging data (720). The method may also optionally include the step of managing smelting activities (730) based on the cover material information.

The step of obtaining the images (700) may be completed via any suitable imaging device, such as any of those described above. Thus, the images may be in any suitable color, black-and-white, digital (702), or analog (704) format, to name a few.

The step of producing imaging data may be completed in a variety of ways. For example, and with reference to FIG. 7b, the producing imaging step (710) may include any one of a textural analysis (712), a color analysis (714) and/or a geometrical analysis (716).

The textural analysis (712) may include any of the above-referenced statistical, structural, model-based and/or transform-based analyses. In one embodiment, the analysis is a statistical analysis that includes a GLCM analysis. In one embodiment, the analysis is a structural analysis and includes pattern matching algorithms. In one embodiment, the analysis is a model-based analysis and includes a Markov random fields analysis. In one embodiment, the analysis is a transform-based analysis and includes WTA.

The color analysis (714) may be any suitable analysis to determine the color differential within the image. In one embodiment, the color analysis (714) comprises an RGB analysis, such as any of a full distribution, a mean and standard deviation, and/or a PCA decomposition analysis, as described above.

A geometrical analysis (716) may be completed to produce imaging data. In one embodiment, the geometrical analysis (716) includes a Watershed-style analysis.

Referring now to FIGS. 7a and 7c, the step of producing cover material information based on imaging data (720) may be completed via any suitable method and/or device. In one embodiment, a statistical analysis (722) is undertaken with respect to the imaging data to build and/or maintain a model (726). The model may then be used to output cover material information (728), such as predicted ratios/amounts of alumina particulate and/or electrolytic bath particulate. For example, imaging data may be input into the model (724), and cover material information may be output (728) based on the model (726). The input imaging data may also be utilized to maintain a model (726), such as via statistical analysis (722).

The statistical analysis (722) may be any of the aforementioned statistical analysis utilized to build and/or maintain a model (726), and/or output cover material information (728), such as predicted alumina content and/or electrolytic bath particulate content. In one embodiment, a regression methodology is part of the statistical analysis, such as any of an OLS, and/or PLS regression methodology. NIPALS may be used to determine whether a produced model is suitable (e.g., prevent over-fitting of the model), and thus may be used to build/maintain prediction models. Other suitable statistical analysis may also be utilized to build/maintain the model (726) and/or output cover material information (728). Furthermore, secondary data (729), may be utilized to build and/or maintain the prediction model. In one embodiment, the secondary data includes at least some physical data (729a) and/or chemical data (729b) relating to the cover mixture or its components. In one embodiment, the secondary data (729) relates to physical and/or chemical properties of the alumina particulate. Alumina may have different qualities based on the supplier and/or alumina production method. Indeed, even from a single supplier, alumina quality may exhibit substantial differential in alumina properties (e.g., particle size distribution). Change is particle size distribution may impact the accuracy of the prediction model due to the sudden changes in the imaging data that will be realized based on cover materials having new alumina content qualities. For example, a sudden increase in the amount of coarse alumina may adversely influence the prediction model since the textural analysis will see more coarse textures similar to those seen on samples of low alumina composition. To account for these variations, secondary data relating to alumina characteristics (e.g., particle size distribution) be utilized as part of the building/maintenance of the prediction model step (726).

In one embodiment, the secondary data relates to physical and/or chemical properties of the electrolytic bath particulate. The alumina composition of the electrolytic bath particulate may vary over time due to inventory management, potroom cleaning status, anode cleaning operation and hot bath treatment, to name a few. Variations in alumina composition of the electrolytic bath particulate may adversely influence the prediction model. To account for these variations, secondary data relating to cover material characteristics (e.g., data from a periodic XRF analysis of cover materials) may be utilized as part of the building/maintenance of the prediction model step (726).

In one embodiment, the secondary data includes time data (729c) relating to the cover material and/or the physical data (729a) and/or chemical data (729b). In one embodiment, the secondary data includes a time lag associated with a physical and/or chemical measurement of the cover material so as to predict the types of cover materials currently in use.

Referring back to FIG. 7a, the step of managing smelting activities (730) may include any activity that facilitates management of smelting activities based on the cover material information. In one approach, a cover material composition is adjusted (732) based on the cover material information. In a related approach, a cover material feed rate is adjusted (734) based on the cover material information, such as on a per electrolysis cell basis (736). In one approach, the amount of alumina content of one or more electrolysis cells is determined (738), such as via any suitable technique. In a particular approach, a suitable bath probe (739) may be inserted into the electrolytic bath of each electrolysis cell and the alumina content may be determined via the bath probe. One such suitable bath probe is described in U.S. Pat. No. 6,942,381, which is incorporated herein by reference. Thus, in one approach, a method includes the steps of determining the alumina concentration in an electrolytic bath of one or more electrolysis cells, communicating at least some alumina concentration information to a control center or other suitable computerized device, determining a cover material composition, and providing a suitable cover material to at least one electrolysis cell of a potline (e.g., in response to the alumina concentration information). In one embodiment, alumina content of the cover material is adjusted for each electrolysis cell of the potline.

### EXAMPLES

### Example 1

### Conventional Cover Material Analysis

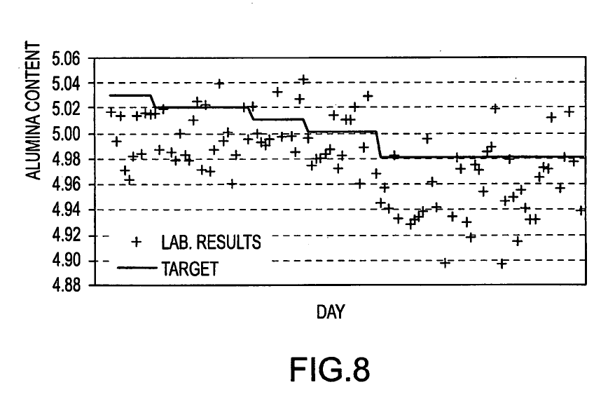

Conventional X-ray fluorescence spectroscopy (XRF) was used to measure alumina content of cover materials for 30 days. The target alumina content versus the XRF measured alumina content is illustrated in FIG. 8. The actual alumina content often varied from the target alumina content, and the actual versus target alumina content even varied within a day. Due to the time and labor intensiveness of XRF analysis, inadequate information relating to cover material composition may be experience with traditional XRF analysis.

### Example 2

### Imaging of Cover Material

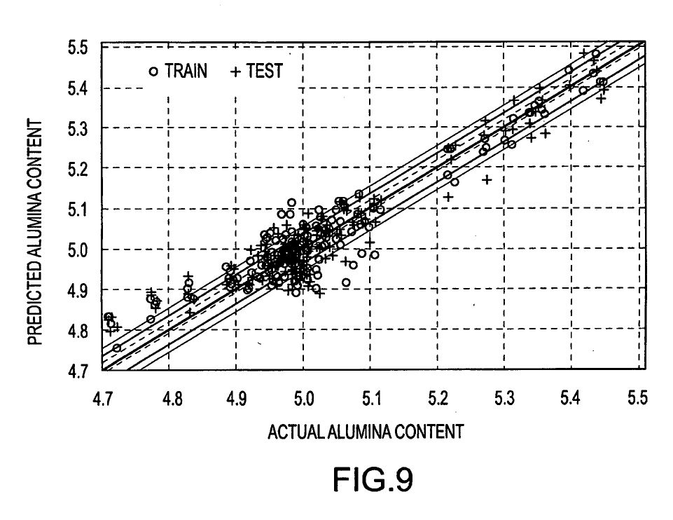

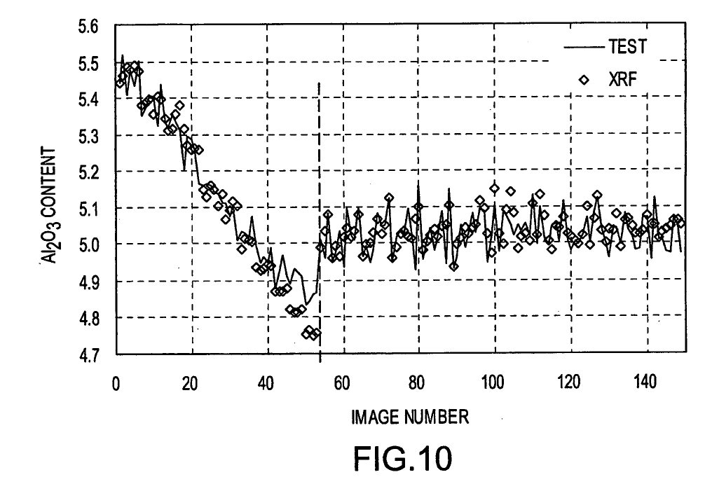

An imaging system similar to the illustrated in FIG. 2 is produced. Various cover material samples (˜250 g) are poured in a nonreflective dark metal pan of 18×13×3 cm. The pan is shaken in order to obtain an even cover material surface. An image of the sample is obtained via the imaging device. XRF analysis of the various samples are completed to determine the alumina content of the samples. The amount of alumina in each sample is correlated to imaging data of each image, and a model is built using the XRF determined alumina content, WTA and PLS regression, as described above. The regression model accurately determines the amount of alumina in each sample, as illustrated in FIGS. 9 and 10. Thus, it may be possible to quickly and accurately determine cover material composition via imaging systems and make appropriate adjustments based thereon. Indeed, cover material composition and/or cover material feed rates may be readily adjusted for one or more electrolysis cells of a potline based on the cover material information.

While the present disclosure has been described in terms of use of imaging systems for determining composition of cover materials for aluminum electrolysis cells, it will be appreciated that the described imaging systems may be utilized to determine the composition of cover materials, or other feed materials, of other metal electrolysis cells. Furthermore, while the instant disclosure has been described in reference to anodes, it will be appreciated that the instant disclosure may also be employed with respect to other types of electrodes, such as cathodes. Moreover, while various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A system comprising:
an aluminum electrolysis cell adapted to contain an electrolytic bath;
a feeder configured to provide a cover material to the aluminum electrolysis cell, wherein the cover material comprises alumina and electrolytic bath particulate;
an imaging device configured to capture images of the cover material;
an image processor configured to analyze the images and output imaging data relating to the cover material;
a data analyzer configured to analyze the imaging data and output cover material information.

2. The system of claim 1, wherein the data analyzer is configured to utilize a cover material prediction model based on at least one of the cover material information and the imaging data to determine a cover material composition, wherein the cover material composition comprises composition information relating to at least one constituent of the cover material.

3. The system of claim 2, wherein the data analyzer is configured to output the cover material information based on an input of imaging data into the prediction model, wherein the imaging data comprises at least one of textual information, geometrical information and color information.

4. The system of claim 2, further comprising:
secondary data, wherein the secondary data includes information relating to at least of the (i) physical properties, (ii) chemical properties, and (ii) time of use data, of the cover material.
wherein the secondary data is supplied to the data analyzer, and wherein the data analyzer is configured to utilize the secondary data in the output of the cover material information.

5. The system of claim 4, wherein the secondary data includes time of use data relating to the alumina of the cover material.

6. The system of claim 3, wherein the image processor is configured to analyze the images and output at least one of the texture information, the geometrical information and the color information associated with the images; and
wherein the imaging data includes at least one of the texture information, the geometrical information and the color information.

7. The system of claim 6, wherein the data analyzer is configured to perform a statistical analysis of the imaging data to produce the cover material information.

8. The system of claim 7, wherein the data analyzer utilizes a regression analysis to produce the cover material information.

9. The system of claim 2, wherein the cover material information comprises information relating to the concentration of alumina in the cover material.

10. A method comprising:
(a) operating an aluminum electrolysis cell;
(b) supplying cover material to the aluminum electrolysis cell, wherein the cover material comprises alumina and electrolytic bath particulate;
(c) obtaining, concomitant to the supplying step (b), images of the cover material;
(d) producing cover material information based on the images; and
(e) managing the operating an aluminum electrolysis cell step (a) based on the producing cover material information step (d).

11. The method of claim 10, wherein the managing step (e) comprises:
adjusting the concentration of at least one of alumina and electrolytic bath particulate in the cover material based on the cover material information.

12. The method of claim 10, comprising:
(f) after the obtaining images step (c), producing imaging data based on the images; wherein the cover material information is based on the imaging data.

13. The method of claim 12, wherein the producing step (f) comprises:
producing at least one of textural information, geometric information and color information about the images;
wherein the cover material information is based on at least one of the textural information, the geometric information and the color information.

14. The method of claim 12, wherein the producing cover material information step (d) comprises:
completing a statistical analysis based on the imaging data; and
outputting the cover material information in response to the statistical analysis.

15. The method of claim 14, wherein the completing a statistical analysis step comprises:
maintaining a cover material prediction model based on the imaging data.

16. The method of claim 15, wherein the maintaining a cover material prediction model comprises:
utilizing secondary data to maintain the cover material prediction model, wherein the secondary data relates to at least one of (i) physical properties, (ii) chemical properties, and (ii) time of use data, of the cover material.

17. A method comprising:
(a) operating an aluminum electrolysis cell;
(b) supplying a first material to the aluminum electrolysis cell, wherein the first material comprises a first constituent and a second constituent;
(c) obtaining, concomitant to the supplying step (b), images of the first material;
(d) producing constituent information based on the images; and
(e) managing the operating an aluminum electrolysis cell step (a) based on the producing constituent information step (d).

18. The method of claim 17, wherein the constituent information comprises information relating to a concentration of at least one of the first constituent and second constituent of the first material.

19. The method of claim 17, wherein the constituent information comprises information relating to a quality of at least one of the first constituent and second constituent of the first material.

20. The method of claim 17, wherein the constituent information comprises information relating to a of at least one of the first constituent and second constituent of the first material.
